(19) United States
(12) Patent Application Publication
(10) Pub. No.: US 2009/0155919 A1
(43) Pub. Date: Jun. 18, 2009

(54) High throughput drug screening method

(75) Inventors: Myron J. Block, Jupiter Island, FL (US); Cristobel Block, Jupiter Island, FL (US)

Correspondence Address: Edwards Angell Palmer & Dodge LLP, P.O. Box 55874, Boston, MA, 02205, US

(73) Assignee: Optix, LLP

(21) Appl. No.: 12/002,599

(22) Filed: Dec. 17, 2007

(51) Int. Cl. G01N 21/00

(52) U.S. Cl. 436/164

(57) ABSTRACT

The present invention uses the small temperature changes from reactions and utilizes them in high throughput screening methods. Briefly, a thermal block containing a series of thermally isolated wells is used so that a reaction can take place in each well without affecting the temperature of any other well. A chemical or biological reaction, such as a binding reaction, is allowed to occur in each well or chamber and the optical properties of the all of the wells are monitored using optical, preferably Kromoscopic, measurements. A determination of temperature in each of the wells from those Kromoscopic measurements can be used to determine if reaction occurred.

### BACKGROUND OF THE INVENTION

Achieving high throughput analysis is a serious problem in the context of drug discovery as thousands of compounds must be screened to determine reactivity. However, some of the same issues are found in other types of clinical analysis such as in a commercial laboratory. A common problem with high throughput screening is that there may be multiple steps required to determine if there has been a reaction between two molecules. This applies to both screenings that determine the identity or presence of one of the molecules, such as is utilized in clinical labs, and to high throughput screening for pharmaceutical development. The reason why multiple steps are used is that most reactions do not cause a color change or other easy to identify physical property, so there are often difficulties in determining whether a reaction has occurred. To solve this problem, a pre-step of “tagging” one of the molecules using a fluorophor or a quencher, or otherwise providing an additional reaction to identify that a reaction has taken place, e.g., using an ELISA reaction, is necessary. Pre-tagging a component can be expensive and time consuming, even if it speeds up the screening reaction. There may be stability problems with the tagged component or enzymes used in the reaction. This pre-step is not a major issue if only a few assays are conducted, but if hundreds or thousands of assays are carried out in a day, the pre-step can require substantial set up time or the use of additional staff. Thus, there is a need for an assay system that is rapid and accurate but does not rely on tagging one of the components.

It has long been known that binding or other chemical reactions between two molecules are normally exothermic or endothermic; that is, they either give off or require the addition of heat in order to occur. If the reaction takes place in a liquid, this change in energy state can change the temperature of the surrounding solution. While this temperature change has been used to a limited degree to determine the course of reactions, the temperature differences can be difficult to measure, particularly if small levels of reactants are used as is often the case in drug screening,. In addition, the methods that have been used to quantify these changes, such as resistance measurements, are not readily adaptable to high throughput screening.

Optical measurements without a pre-tagging or other pre-step would appear to have promise but there are inherent difficulties. Kromoscopy, which utilizes a near infrared (“NIR”) analogy to color perception in the visible region, has shown sensitivity beyond classic spectroscopic measurements and chemical measurements in some circumstances. Kromoscopy relies on the illumination of the object or liquid with broadband radiation (an analog of white light in the visible), and use of a series of spectrally overlapping filters to detect the reflected, emitted or transmitted radiation to determine the object's relative “color.” This approach is discussed in U.S. Pat. No. 5,321,265, the disclosure of which is incorporated herein by reference. This method provides high sensitivity to low concentrations of molecules but is not easily adapted to high throughput screening. However, it has been found that infrared Kromoscopy in aqueous solutions can be sensitive to changes in temperature of the water. While these temperature changes can be easily ignored when making measurements on constituents such as hemoglobin, they are more difficult to deal with for low concentration materials such as glucose because the size of the signal is much smaller relative to the changes arising from changes in temperature. In fact, it appears that very small differences in temperature may need to be corrected for in a Kromoscopic analysis. These small temperature changes are along the same order of magnitude as those for the liquid in reactions and thus it may be possible to use the means of correcting for temperature as a measuring tool. By selection of appropriate filters, one can determine or correct for the effect of temperature on the optical properties of the water.

### SUMMARY OF THE INVENTION

The present invention measures the modification of the optical properties of water caused by the small temperature changes from the heat of reaction and utilizes these measurements in high throughput screening methods. Normally, a thermal block containing a series of thermally isolated wells is used so that a reaction can take place in each well without affecting the temperature of any other well. Any type of thermally isolated reaction chamber could be used in lieu of a thermal block. Alternatively, the spatial or temporal changes in the optical properties of a well or test tube is measured. A chemical or biological reaction, such as a binding reaction, is allowed to occur in each well or chamber and the optical properties of the all of the wells are monitored, preferably at the same time, using optical, most preferably Kromoscopic, measurements. A measurement of the change in the optical properties caused by a temperature change in a well, preferably monitored using Kromoscopic measurements, can be used to determine if reaction occurred.

In more detail, the present invention provides a method of determining whether there is an interaction between a ligand and a target in solution based on a thermal change in said solution. The ligand and the target are allowed to interact in a solution and The solution is optically monitored for changes in temperature that are indicative of an interaction between the ligand and the target. The vessel which is monitored, such as a well or test tube, is kept thermally isolated to ensure that any change in temperature is from the reaction of said ligand and said target. There are several ways to thermally isolate the reaction vessel. It can be isolated by enclosing the majority of the vessel in a thermal block or a temperature control unit can be used. If a thermal control unit is used, there could be heating components, cooling components, or components that provide heating and cooling. Alternatively, monitoring each well or vessel temporally or spatially can indicate if a reaction has occurred without the complete thermal isolation.

A preferred method of carrying out the present invention has the reaction take place in a well in a multi-compartment well plate such as a 96 or 384 compartment well plate. If individual tubes are used, they are preferably in a multi-tube array. The method of the invention can take place in solution, preferably an aqueous solution, or at least one of the target and the ligand may be bound to a solid support such as the reaction vessel or well. Alternatively, a separate solid support could be used.

To carry out a preferred type of Kromoscopic measurement, each of the wells in a multiwell plate is illuminated with broadband infrared radiation and the radiation transmitted, or reflected from the solution is detected at a detector. Alternatively, multiple sources, such as light emitting diodes (“LED”) may be used as illumination sources. The preferred illuminating radiation for aqueous based systems is near infrared radiation having a wavelength of about 900-1500 nm. If other systems are used, the wavelength may be adjusted. The detector may include a plurality of detection units, and each of the detection units detects a specific region of the spectrum, normally by filtering the detection unit to achieve the desired performance. Alternatively, a single detector having multiple filters may be used. The filters may be in the form of a filter wheel or some other device that provides different filtering at different times, or a modified Bayer plate, having a grid or array of different filters may be used. Normally, the detected region of the spectrum for each of the filters or detection units has at least partial overlap with the detected region of the spectrum for another of the filters or detection units. The change in temperature of the solution due to the interaction of the ligand and the target causes a change in the optical properties of the solution that can be distinguished from external temperature changes based on a variety of methods including temporal or spatial information. For example, a transient change in the temperature of the system can cause a change in temperature in a steady gradient pattern or having a spatial gradient across a well, while a change due to reaction is likely to be a sharper temporal spike or a change without the spatial gradient. While it is possible that each of the wells in a multi-compartment well plate can viewed optically with a scanning head that is scanned to measure the temperature of each well separately or the multi-compartment well plate is moved beneath an optical device to measure the temperature of each well separately, a device that measures distribution within the wells, and all the wells simultaneously, is preferred.

### BRIEF DESCRIPTION OF THE DRAWING

FIG. 1 illustrates a device for carrying the method of the invention, with four detector units shown, each having a different filter;

FIG. 2 illustrates a variant of the device shown in FIG. 1, with a single detector unit and a series of filters that filter light coming to the detector sequentially; and

FIG. 3 illustrates a variant of the device shown in FIG. 2, with a single detector unit and a set of multiple sources having partially overlapping emission bands.

### DETAILED DESCRIPTION

The present invention is based on the recognition that the heat of reaction of a binding process can modify the optical properties of the surrounding liquid and that can be used to determine if binding has occurred. Kromoscopy provides an optical platform sufficiently sensitive to measure the small changes that occur based on a change in the optical properties of a liquid such as aqueous solutions from the heat of reaction. In addition, Kromoscopy provides a platform that can be used to measure a number of wells containing reactants at once, thus making it amenable for high throughput screening.

Kromoscopy utilizes broadband illumination of a sample followed by detection with detection units having spectral overlap characteristics. Water is well known to have an absorption spectrum with small shoulder changes in absorbance at 960 nm and 1450 nm. These spectral characteristics can be used with infrared illuminating radiation and known detectors to provide a sensitive assay system. For frequencies up to about 1100 nm, Si detections have high sensitivity and low cost. For wavelengths higher than 1100 nm, and including 1450 nm, InGaAs detectors can be used. However, the InGaAs detectors have about 100 times lower sensitivity than Si detectors and are much higher cost. Therefore, for most uses, Si detectors are preferred.

The advantages of using Si detectors outweigh the disadvantages of not going out to 1450 nm. Si detectors are used in a number of devices including digital cameras and other CCD devices. In digital cameras, an IR blocking filter is used to block the IR wavelength and a Bayer plate imparts color to the photograph. Removal of the Bayer plate and the IR blocking filter and insertion of proper filters can allow digital cameras to be used as detection units. In the alternative, any common Si detector can be used with proper filtering. If two or more detection units are used, each should have an overlap frequency with the other(s) near the 960 nm band of water. Use of these filters allows the ratio of the values obtained to be correlated to a shift in the optical properties caused by a change in the temperature of the liquid.

Systems of this type are sensitive to 0.001° C. Using the type of small wells in a common 96 well plate (about 0.2-0.4 ml), the heat of reaction from a small number of molecules can cause more than the requisite heat increase to be measured, assuming the well is sufficiently thermally isolated.

### EXAMPLE

A test system to show the effectiveness of the present invention can be constructed using two wells of a 96 well plate and a pair of digital cameras. One well (the reaction well) includes a solution of the target compound and the other (the control well) does not have the target compound. While a solution reaction is preferred in most cases, the well may be coated with one reactant. Methods of coating the wells of a 96 well plate are well known, as are preparing a control well. If the target compound is a protein and standard plastic 96 well plates are used, the sample solution is normally placed in the reaction well followed by a coating solution of a material like bovine serum albumin to minimize nonspecific reaction. The control well may have the same initial solution as the reaction well except it is lacking the target molecule and then the control well is also coated with the coating solution.

The 96 well plate 100 is placed in a thermal block or water bath 120 to keep the temperature constant. The thermal block or water bath 120 may have a control unit (not shown) having one or more heating or cooling units to keep the temperature constant. The reaction well 101 and the control well 102 of 96 well plate 100 are located so that each may be visualized by the same two or more cameras 150. Two cameras, 150a and 150b, are illustrated, but more may be used. Cameras 150a and 150b are standard digital cameras having the Bayer plates and IR filters removed and they are optically directed to view the wells. Preferably, cameras 150a and 150b are located such that the optical path is equivalent in length; that is, they are optically congruent. Each camera (150a and 150b) has an associated filter (160a and 160b, respectively) that limits the wavelength range that can reach the internal silicon (Si) detector (not shown). Each of the two or more filters 160 are centered about different wavelength but have a partial overlap in wavelengths they allow through with at least one other 160. For example, one camera (150a) could have an RT-830 filter 160a (Hoya) while the other could have a RM-90 filter 160b (Hoya). These filters have an overlap near the 960 nm band of water.

If the target or the ligand is pre-bound to the well, the other is added in an aqueous solution in a pre-determined amount. If neither the ligand nor target is pre-bound, they are both added to the well in aqueous solution so that the total volume is a known amount. The target and ligand, if they form a binding pair, react and the energy of binding heats (or cools) the aqueous solution in the well. Even though the temperature difference is small, the change in temperature causes a change in the optical properties of the aqueous solution. This change in optical properties modifies the absorbance of the solution and the Si detectors measure different values, changing the ratio of absorbance from one detector unit to the other because of the difference in the filters. If more than two detector units are utilized, even more accurate measurements can be made.

Using cameras 150 with the associated filters 160 as the detection units, the infrared light from each well can be identified spatially by proper assignment of pixels. Thus, all 96 wells can be viewed simultaneously. The control well can be “seen” at the same time as the reaction well because the camera detector unit shows spatial difference. The Si detector gives a value for each pixel in the viewing field and using software, one can assign certain pixels to the location of each well. Although this system has been described for only a reaction well and a control well, many more wells could be viewed simultaneously. Since a 5 megapixel camera has 5000 pixels, assigning 25 to each well of a 96 well plate would still leave over half unassigned. The reaction and measurements can take place in seconds or less and the next plate can be moved in position using convention plate moving machinery standard in the field of high throughput screening. The measurement cycle restarts, leading to the ability to screen many samples in a short time. Alternatively, each well or a subgroup of the wells could be viewed and the plate 100 is moved so that each well or subgroup is viewed in series. While this has certain disadvantages in speed and the fact that one is not viewing the wells simultaneously, it allows more pixels to be assigned to each well so it might provide better temperature discrimination.

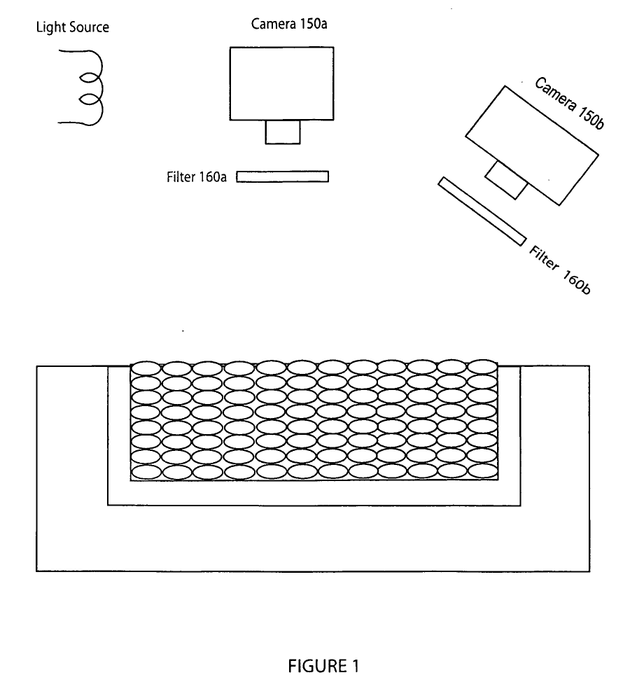

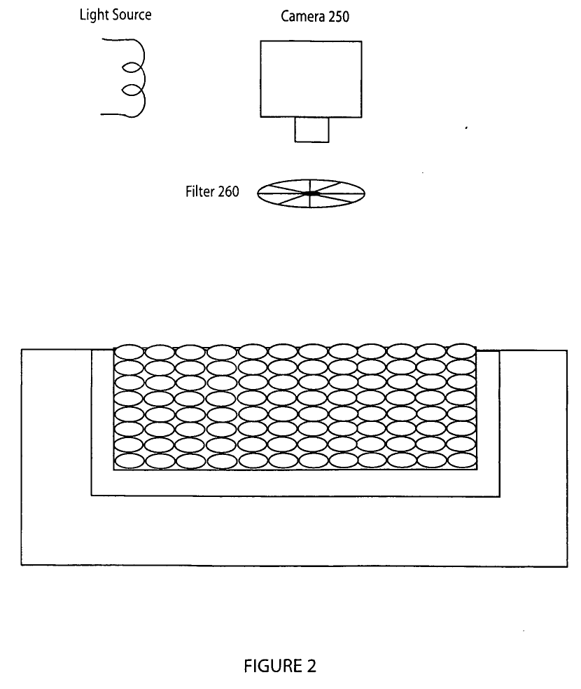

FIG. 2 shows a variant of the device of FIG. 1, using only a camera 250 as a single Si detector unit rather than two or more units. As described with respect to FIG. 1, the 96 well plate 200 is placed in a thermal block or water bath 220 to keep the temperature constant. The reaction well 201 and the control well 202 of 96 well plate 200 are located so that each may be visualized by the camera 250. In this variant system, only one camera 250 is used. Camera 250 is a standard digital cameras having the Bayer plate and IR blocking filter removed and is optically directed to view the wells. Camera 250 has an associated filter unit 260 that limits the wavelength range that can reach the internal silicon (Si) detector (not shown). Filter unit 260 contains two or more filters 260 centered about different wavelength but having a partial overlap in wavelengths that they allow through with at least one other filter in filter unit 260. For example, one filter could be an RT-830 filter (Hoya) while the other could be a RM-90 filter (Hoya). These filters have an overlap near the 960 nm band of water. The filters in filter unit 260 can be on a filter wheel or some other device that allows one and then another of the filters to be inserted into the optical path sequentially. This means that wells on 96 well plate 200 are viewed simultaneously with one wavelength range suing a first filter, then a second filter is used and the wells are viewed again with a second wavelength. This temporal separation is not preferred but allows the use of fewer Si detection units. As described with respect to FIG. 1, single wells or subgroups of wells can be viewed rather that the plate 200 as a whole. Alternatively, a modified Bayer plate could be used instead of filter wheel 260. This modified Bayer plate has a grid or array of filters, each having partial overlap in response to the other. For example, a checkerboard array using a plurality of RT-830 filters and a plurality of RM-90 filters could be used. The resulting “image” can be reformed using a demosaicing algorithm and used as otherwise described to determine if a reaction has taken place.

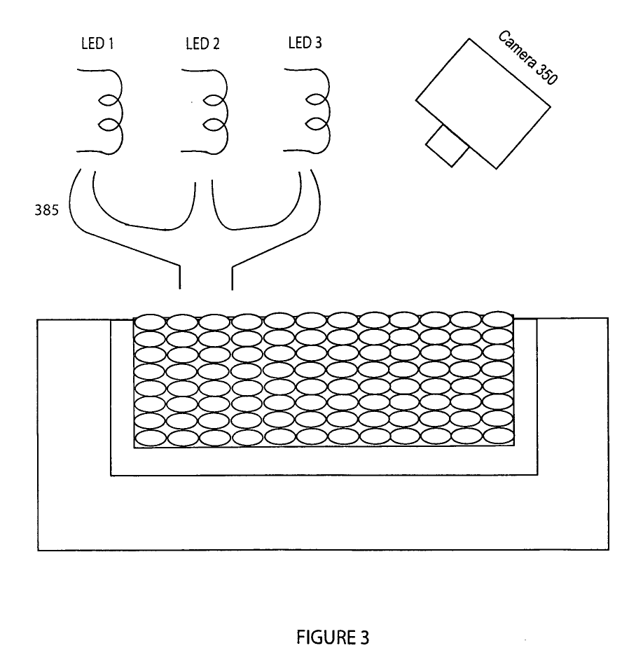

FIG. 3 shows another variant of the invention, in which multiple sources are employed with a single detection unit. Preferably, the sources are light-emitting diodes (LEDs) with partially overlapping emission bands, and, as in FIG. 2, the detection unit is a camera rendered sensitive to near infrared radiation. As described with respect to FIG. 1, the 96 well plate 300 is placed in a thermal block or water bath 320 to keep the temperature constant. The reaction well 301 and the control well 302 of 96 well plate 300 are located so that each may be visualized by the camera 350. In this variant system, only one camera 350 is used. Camera 350 is a standard digital camera having the Bayer plate and IR blocking filter removed and is optically directed to view the wells. The wells are illuminated preferably by a multi-color LED source 380, whose emissions are directed to all of the wells by fiber-optic means 385. The LED source output is alternated cyclically among all the different source elements; this can be synchronized with the data acquisition by the camera so that each frame is taken with a different color illuminant. As in the previous variants, data may be acquired on a single well, or by proper arrangement of the optical components, of the plate 300 as a whole or any sub-part of plate 300.

The foregoing examples are merely illustrative of the invention and are specifically deemed not limiting. The present invention is described in the following claims.

What is claimed is:

1. A method of determining whether there is an interaction between a ligand and a target in solution, where an interaction between said ligand and said target produces a thermal change in said solution, comprising the steps of:
allowing said ligand and said target to interact in a solution in a vessel; and
optically monitoring said solution for changes in optical properties that correspond to changes in temperature, whereby a change in temperature is indicative of an interaction between said ligand and said target.

2. The method of claim 1 wherein said vessel is kept thermally isolated to ensure that any change in temperature is from the reaction of said ligand and said target.

3. The method of claim 2 where said vessel is thermally isolated by a thermal block.

4. The method of claim 2 where said vessel is thermally isolated by a temperature control unit.

5. The method of claim 4 where said thermal control unit has at least one temperature control unit selected from the group consisting of heating components, cooling components, and components that provide heating and cooling.

6. The method of claim 1 wherein said vessel is a well in a multi-compartment well plate.

7. The method of claim 6 wherein said well is in a 96 compartment well plate.

8. The method of claim 6 wherein said well is in a 384 compartment well plate.

9. The method of claim 1 wherein said vessel is an individual tube.

10. The method of claim 9 wherein said individual tube is in a multi-tube array.

11. The method of claim 1 wherein said optical monitoring is in the form of Kromoscopic measurement.

12. The method of claim 11 wherein said solution is an aqueous solution.

13. The method of claim 13 wherein a Si detector is used to monitor the optical properties of the aqueous solution in the wells.

14. The method of claim 11 wherein all or a subgroup of the wells of a multicompartment well plate are monitored simultaneously.

15. The method of claim 1 wherein at least one of said target and said ligand is bound to a solid support.

16. The method of claim 15 wherein said solid support is said vessel or said well.

17. The method of claim 1 wherein said target and said ligand are in solution.

18. The method of claim 6 wherein each of said wells is illuminated with broadband radiation and the radiation transmitted, or reflected from said solution is detected simultaneously at a detector.

19. The method of claim 18 wherein said illuminating radiation is near infrared radiation having a wavelength of about 900-1500 nm.

20. The method of claim 18 wherein said detector comprises a plurality of detection units, and each of said detection units detect a specific region of the spectrum.

21. The method of claim 20 wherein said detected region of the spectrum for each of said detection units has at least partial overlap with the detected region of the spectrum for another of said detection units.

22. The method of claim 1 wherein a change in temperature due to said interaction can be distinguished from external temperature changes based on temporal information.

23. The method of claim 1 wherein a change in temperature due to said interaction can be distinguished from external temperature changes based on spatial information.

24. The method of claim 1 wherein a change in temperature due to said interaction can be distinguished from external temperature changes based on temporal information.

25. The method of claim 6 wherein said wells in a multi-compartment well plate are viewed optically with a scanning head that is scanned to measure the temperature of each well separately.

26. The method of claim 6 wherein said multi-compartment well plate is moved beneath an optical device to measure the temperature of each well separately.

27. The method of claim 1 wherein a modified Bayer plate is used to provide filtering of a detector unit.

28. The method of claim 1 wherein said vessel is illuminated with a plurality of LED sources, each LED source having a different spectrum of emission from the others but having overlapping wavelengths of emission.
